(19) United States
(12) Patent Application Publication
(10) Pub. No.: US 2023/0050085 A1
(43) Pub. Date: Feb. 16, 2023

(54) COMMERCIAL TAX APPEAL GENERATION SYSTEM

(71) Applicant: Ross LITKENHOUS, Falls Church, VA (US)

(72) Inventor: Ross LITKENHOUS, Falls Church, VA (US)

(21) Appl. No.: 17/954,278

(22) Filed: Sep. 27, 2022

Related U.S. Application Data
(63) Continuation-in-part of application No. 17/726,510, filed on Apr. 21, 2022.
(60) Provisional application No. 63/178,105, filed on Apr. 22, 2021.
(60) Provisional application No. 63/177,993, filed on Apr. 22, 2021.
(60) Provisional application No. 63/177,602, filed on Apr. 21, 2021.

(51) Int. Cl. G06Q 40/00; G06Q 50/16; G06F 40/226

(52) U.S. Cl. CPC G06Q 40/123; G06Q 50/163; G06F 40/226

(57) ABSTRACT

A system for generating commercial real estate tax appeal documents is provided. Financial statements about a property are submitted in various formats to a form generation device, which may collect property data from a variety of external sources. Machine learning models are executed to identify errors or inconsistencies in the data and provide an estimated valuation for the commercial property. Based on the estimated value and comparable sales data, the platform generates tax appeals documentation for user review and submission.

### CROSS-REFERENCE TO RELATED APPLICATIONS

This application claims the benefit of priority as a continuation-in-part of patent application Ser. No. 17/726,510 entitled “Commercial Tax Appeal Generation System” filed on Apr. 21, 2022. The contents of both applications are incorporated herein by reference in their entirety.

### FIELD OF INVENTION

The technical subject matter of this application relates generally to the field of document generation. Specifically, the claimed subject matter relates to a system for generating tax documents having a specialized and jurisdiction-specific format.

### BACKGROUND

Every one to eight years, or possibly more, assessors will calculate the value of commercial real estate for real estate tax assessment purposes. The resulting assessment is used to determine the appropriate amount of property tax rate applied to the property and to be paid by the tax payer. Property tax rates will vary across jurisdictions and taxing entities. Taxing entities can include federal, state, and local governments, as well as other pertinent, or special taxing, districts. For example, school districts, water districts, the city, and the county. Each taxing entity determines its own property tax rate and assessments for real estate tax revenue generation purposes. The sum of these property tax rates represents part of the total tax rate that a real estate owner must pay in taxes on the property. Thus, efficient methods of calculating real estate taxes and appealing assessments and, or property tax rates, could result in significant cost savings for property owners and taxpayers.

### SUMMARY

Various embodiments are directed to a system for generating commercial tax appeal document files. The system receives data from a variety of external sources, parses and formats the data, calculates tax appeal information, and then arranges the resulting calculations within an electronic document in a format acceptable by a tax appeals receiving entity.

One embodiment of the invention is a system including a user computing device having a processor, a display, a network communication interface, and a computer readable medium, coupled to the processor, the computer-readable medium comprising code, executable by the processor. The code may cause the processor to receive at least one real estate document, receive tax information from a user, and transmit the real estate document and the tax information to a remote server. The system may also include a remote server configured to receive a property document and tax information from a user device and identify a taxing entity based on the tax information and the property document. The remote server may also calculate a property valuation and generate one or more tax appeal documents based on the calculated valuation. Finally, the remote server may transmit the tax appeal documents to a taxing entity server.

In another embodiment, of the invention is a system including a user computing device having a processor, a display, a network communication interface, and a computer readable medium, coupled to the processor, the computer-readable medium comprising code, executable by the processor. The code may cause the processor to receive at least one real estate document, receive tax information from a user, and transmit the real estate document and the tax information to a remote server. The system also includes a remote server configured to receive a property document and tax information from a user device, and identify a taxing entity based on the tax information and the property document. The remote server may also calculate a property tax rate for the taxing entity, generate one or more tax filing documents, and transmit the tax filing documents to a taxing entity server.

In still another embodiment, of the invention is a system including a user computing device having a processor, a display, a network communication interface, and a computer readable medium, coupled to the processor, the computer-readable medium comprising code, executable by the processor. The code may cause the processor to receive at least one real estate document, receive tax information from a user, and transmit the real estate document and the tax information to a remote server. The system also includes a remote server configured to receive property documents and tax information form a user device and identify a taxing entity based on the tax information and the property document. The remote server is also configured to calculate a non-ad valorem assessment or tax, also known as a solid waste assessment, to generate one or more non-ad valorem or solid waste appeal documents based on the calculated assessment or tax, and to transmit the tax appeal documents to a taxing entity server.

Additional embodiments include methods and processor-executable code stored on non-transitory computer-readable media for electronic document generation Systems for implementing the same are also contemplated as embodiments.

Additional details regarding the specific implementation of these embodiments can be found in the Detailed Description and the Figures.

### BRIEF DESCRIPTION OF THE DRAWINGS

FIG. 1 shows a block diagram of a network environment suitable for implementing a commercial real estate tax appeals platform according to various embodiments.

FIG. 2 shows a block diagram of a form generation device according to various embodiments.

FIG. 3 shows a block diagram of a user computing according to various embodiments.

FIG. 4 shows a block diagram of information flow in a commercial real estate tax appeals platform according to various embodiments.

FIG. 5 shows a block diagram of process flow in a form generation according to various embodiments.

FIG. 6 shows a block diagram of information flow in an income and expenses submission according to various embodiments.

### DETAILED DESCRIPTION

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

Prior to discussing embodiments of the invention, some terms can be described in further detail.

A “user computing device” may be any suitable computing device that can interact with a user. The user computing device includes computing devices capable of communicating, sending and receiving messages, over a network such as the Internet or a local network. The user computing device may receive data in a variety of formats form multiple external sources and may parse, transform, convert, or otherwise modify the data in order to generate electronic documents having a format specific to those accepted by local tax authorities. User computing devices may be in any suitable form. Some examples of user computing devices include cellular laptops, phones, PDAs, personal computers, tablet computers, workstations and the like.

A “display” may be any electronic output device that displays or renders data in a pictorial or textual format. Displays may include computing device monitors, touchscreen displays, projectors, and the like.

A “graphical user interface” may be an electronic means of providing a visual way to interact with a computing device using items such as windows, icons, and menus.

A “network communication interface” may be an electrical component that enables communication between two computing devices. A network communication interface may enable communications according to one or more standards such as 802.11, BlueTooth, GPRS, GSM, 3G, 4G, 5G, Ethernet, or the lie. The network communications interface may perform signal modulation/demodulation. The network communications interface may include digital signal processing (DSP). Some embodiments may include computing devices that include multiple communications interfaces to enable communications according to different protocols or standards.

An “Electronic message” refers to an electronic message for self-contained digital communication that is designed to be transmitted between physical computing devices. Electronic messages include, but are not limited to transmission control protocol (TCP) messages, user datagram protocol (UDP) message, electronic mail, a text message, an instant message, transmit data, or a command or request to access an Internet site.

A “user” may include an individual or a computational device. In some embodiments, a user may be associated with one or more individual user accounts and/or mobile devices or personal computing devices. In some embodiments, the user may be an employee, contractor, or other person having authorized access to make use of a networked computing environment. In other embodiments, the user may be a group of employees, contractors, or other personnel such as a product development team, a department, or division of an organization.

A “server computing device” is typically a powerful computer or cluster of computers. For example, the server computer can be a large mainframe, a minicomputer cluster, or a group of servers functioning as a unit. In one example, the server computer may be a database server and may be coupled to a Web server. The server computing device may also be referred to as a server computer or server.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable computer-readable device or devices that can store electronic data. A suitable memory may comprise a non-transitory computer readable medium that stores instructions that can be executed by a processor to implement a desired method. Examples of memories may comprise one or more memory chips, disk drives, removable memory, etc. Such memories may operate using any suitable electrical, optical, and/or magnetic mode of operation.

Commercial real estate (CRE) is property generally acquired, owned, or developed for the purposes of generating income, value or investment return for the owner, operator, or investor. CRE also includes buildings that are used exclusively for business-related purposes or to provide a workspace or place to conduct business, rather than as an owner occupied living space, which would instead constitute residential real estate, such as a single family home. Commercial real estate, however, does include multi-family rentals, such as apartments. Commercial real estate also may be leased to tenants to conduct business activities. Such real estate may include everything from a single storefront to a huge shopping center. Further, commercial real estate may include, but are not limited to, several categories, such as apartment buildings, retailers, office space, hotels and resorts, strip malls, restaurants, warehouses, data centers, manufacturing facilities, and healthcare facilities.

The various embodiments include a system for generating electronic documents for commercial real estate tax appeals. Commercial real estate taxation is a complicated and resource intensive process requiring property owners to gather information from multiple sources and then calculate values for entry into tax forms. When an owner believes that taxes have been applied incorrectly or that an assessment of value is incorrect, the property owner or manager must file a tax appeal, which may require obtaining independent tax assessments, gathering data from other sources to prove claimant's case, and the filling out of numerous tax appeals forms. Improperly filling out the forms, or failing to properly calculate values and submit proper and compelling evidence may result in the denial of an appeal or an appeal outcome that does not benefit the appellant/taxpayer.

The disclosed embodiments enable users to input information related to their commercial real estate tax bill or assessment, which is passed as input to algorithms determine if the tax payment or assessment is too high, too low, or approximately correct. The commercial real estate tax appeal generation system uses changes made by users and information submitted by users to identify the magnitude of the opportunity or savings as well as the data points and evidence to support the opportunity for savings. The platform also “flags” potential risks to appealing if the “mistakes” identified could result in an increase to a tax bill or assessment if pursued for appeal.

Various embodiments described herein provide for systems, computing devices, and methods for executing the generation of tax appeal electronic documents. Data is gathered from several external data sources via a user computing device over a network. The user computing device collects this data and executes a series of software code segments to calculate correct or revised tax and assessment values. Relevant data and corrected tax values are converted into a format that may be inserted into an electronic document that is capable of being read by a computing device of a local tax authority. In this way, the various embodiments may not only improve accuracy, but may also reduce the likelihood that a tax appeal will be rejected by generating electronic appeal documents in a proscribed format.

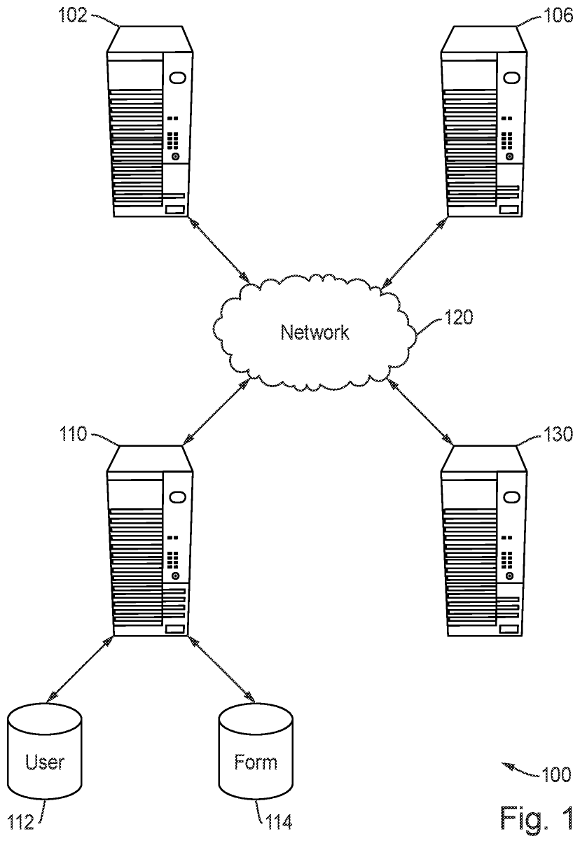

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

FIG. 1 illustrates an exemplary system 100 for commercial real estate tax appeals platform according to various embodiments. With reference to FIG. 1, the commercial real estate tax appeals platform may be a document generation system 100 may generate commercial tax documents based on information obtained from a number of data sources. The user computing device 102 may receive a variety of data related to a unit of commercial real property, such as via a use input device connected to the user computing device 102 or data transmitted over a network 120 from one or property information sources 106. Data related to the commercial property may be aggregated by the user computing device 102 and transmitted over the network 120 to a form generation device 110 via an application programming interface (API) for analysis and tax form generation. This data may be stored in data stores 112, 114 accessible by the workflow management computing device 102. Machine learning algorithms may be run on the data stored in the data stores 112, 114 to identify potential form errors, tax audit risks, and data points that produce positive or negative outcomes for the users. The results of the machine learning analysis may be stored in the data store 115 or exported to various systems within the broader system 100, or externally as needed. Software applications running on the form generation device 106 use the results of the machine learning algorithms and at least a portion of the commercial property data to generate tax forms specific to a particular taxing jurisdiction.

The system 100 enables user computing devices such as user computing device 102 to transmit data related to commercial properties to a tax form generation system to automatically generate electronic documents for submission to taxing authorities. Each user computing device can receive and collect commercial property data from several sources. Data may be transmitted to the user computing device 12 for external sources such as financial institutions, other taxing authorities, property recordation offices, and the like. Data may also be obtained in the form of document image files, such as those obtained from a camera or image/document scanner. Additional data may be provided by a user via input devices such as keyboard, mouse, trackpad, microphone, or the like. The user computing device may aggregate and, or transmit this collective data and any user-specific data to the form generation device 110 via an API over network 120.

The form generation device 110 may host a website with a user interface that enables transmission of commercial property to the form generation device 110. The form generation device 110 evaluates thee provided data to identify any applicable taxing jurisdictions for the commercial property, e.g., local and state. Any data submitted by a user may be scrubbed to remove non-essentially personally identifying or sensitive information. The remaining data will be analyzed via one or more algorithms to identify errors, commissions, and otherwise ensure accuracy of provided commercial property or user dat. This may include optical character recognition of image and document files, parsing of structured data, and extraction of information relevant to a selected jurisdiction's commercial real estate tax forms. Extracted information is populated into electronic tax forms for a selected jurisdiction. A copy of the completed forms is transmitted to the user computing device 102 and rendered by a display for user review and confirmation. Once approved, the forms may be submitted electronically to the selected taxing jurisdictions or printed off and manually submitted.

The form generation device 110 may be in communication with several data stores such as user data store 112 and form data store 114. By way of example, data store 112 may collect and store user related data and property information. User identifiers may be stored instead of user personally information to reduce security risks and improve privacy regulation compliance. Each commercial property owned by the user or for which the user is responsible for filing tax information, may be stored in data store 112 in association with the user identifier. Information stored in data store 112 may be used to populate owner information in the generated tax forms.

Data store 114 may collect and store commercial real estate tax form data and compliance rules for tax jurisdiction. Information in this data store may be updated at regular intervals or as needed to complete form generation for a user. Templates and electronic form files may be stored in association with a tax jurisdiction or authority. The data store 114 is also updated to include changes to commercial real estate tax laws and regulations. Algorithms or applications for converting user data and commercial property data into electronic forms may be stored within the data store 114 or on form generation device 110. Initial drafts of the electronic forms may be analyzed by the form generation device 110 for errors and omissions before presentation to a user.

In various embodiments, data stores 112 and 114 may be multiple database servers, a data lake, or other form of singular cloud storage including multiple databases. Each data store 112, 114 may include one or more data retention and maintenance structures. The data stores may be any suitable data storage in operative communication with the form generation device 110. Location of the data stores 112, 114 within system 100 is fungible, such that the data stores may sit in any location, so long as it is in communication with the form generation device 110. The data stores may retain data generated, modified, or otherwise published by various systems of the system 100 as part of commercial property tax form generation and analysis. The data stores may also store models, analysis scripts, or other frequently used software code used to perform analysis of the stored data.

The form generation device 110 accepts and collects data from a variety of data sources, which it uses to identify the relevant jurisdictions for a selected commercial property. The form generation device 110 executes filtering models to identify errors in the provided data sets before using another model to identify the best valuation model for a jurisdiction and type of property. The selected valuation model is executed to estimate a property valuation, which can be compared to the tax assessment value for the property. If a user of the user computing device 102 elects to move forward with a tax appeal based on the provided predictions, the form generation device 110 uses the collected data and any user property financial data to pre-fill or auto-complete jurisdiction-specific tax appeal forms. The completed forms are transmitted to the user computing device 102 over network 120 for review and final approval. Once approved by the user, the forms are submitted to the selected taxing jurisdictions.

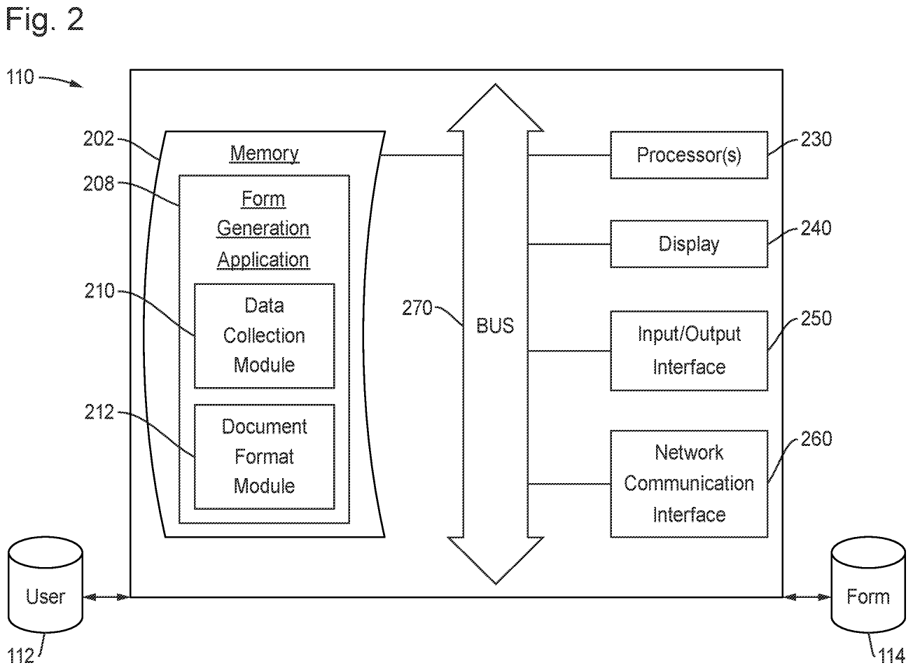

Referring now to FIG. 2, there is shown an example of a computer system within which a set of instructions, for causing the computing system to perform any one or more of the methods discussed herein, may be executed. With reference to FIGS. 1-2, the computer system may correspond to the form generation device 110 of FIG. 1. The form generation device 110 may support the generation, tracking, and analysis of commercial real estate tax appeal forms. In some implementations, the various software modules and data structures stored in and executed by form generation device 110 may be distributed across two or more connected computing devices a workstation and one or more servers.

The form generation device 110 may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware of the virtualized data center. For example, the VM may operate based on computer architecture and functions of computer hardware resources associated with hard disks or other such memory. The VM may emulate a physical computing environment, but requests for a hard disk or memory may be managed by a virtualization layer of a host machine to translate these requests to the underlying physical computing hardware resources. This type of virtualization results in multiple VMs sharing physical resources.

In certain implementations, the form generation device 110 may be connected (e.g., via a network, such as a Local Area Network (LAN), an intranet, an extranet, or the Internet) to other computer systems. The form generation device 110 may operate in the capacity of a server or a client computer in a client-server environment, or as a peer computer in a peer-to-peer or distributed network environment. Form generation device 110 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein for supporting micro-services of a commercial real estate appeals system.

The form generation device 110 includes a processing device such as a processor(s) 230, a memory 202 which includes multiples: a main memory (e.g., read-only memory (ROM), flash memory, dynamic random access memory (DRAM) (such as synchronous DRAM (SDRAM) or DRAM (RDRAM), etc.) and a static memory (e.g., flash memory; a static random access memory (SRAM), etc.), and a data storage device (e.g. data store), which communicate with each other via a bus 270.

Processor 230 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processor 230 may also be one or more special-purpose processing devices such as an application specific integrated circuit (ASIC), a field programmable gate array (FPGA), a digital signal processor (DSP), network processor, or the like. The processor 230 is configured to execute processing logic for performing the operations and steps discussed herein.

The form generation device 110 may further include a network communication interface 260 communicably coupled to a network 110. The form generation device 110 also may include a video display unit such as display 240 (e.g., a liquid crystal display (LCD) or a cathode ray tube (CRT)), an input/output interface 250 including an alphanumeric input device (e.g., a keyboard) and, or a cursor control device (e.g., a mouse), and an optional signal generation device (e.g., a speaker).

The memory 202 may include a computer-readable storage medium (e.g., a non-transitory computer-readable storage medium) on which may store instructions encoding any one or more of the methods or functions described herein, including instructions encoding a tax appeals application 210 for implementing methods for supporting the generation, management, analysis, and transmission of commercial tax appeal forms may also reside, completely or partially, within volatile memory and/or within processor(s) 230 during execution thereof form generation device 110, hence, volatile memory of memory 202 and processor device 230 may also constitute machine-readable storage media.

The non-transitory machine-readable storage medium may also be used to store instructions to implement a tax appeals application for supporting the generation, management, analysis, and visualization of commercial real estate tax appeals forms in a cloud-based system, and/or a software library containing methods that call the above applications. While the machine-accessible storage medium is shown in an example implementation to be a single medium included within memory 202, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the disclosure. The term “machine-accessible storage medium” shall accordingly be taken to include, but not be limited to, solid-state memories, and optical and magnetic media.

Regardless of implementation of the computer-readable storage medium, the form generation application may contain one or more modules of processor-executable instructions for performing various routines and sub-routines of the methods described herein. For example, the form generation application 208 may include a data collection module 210 of instructions for executing the collection of data related one or more commercial properties owned or managed by a user o the system 100. The data may be collected via optical character recognition of scanned images, pdf documents, etc., input directly into a user interface displayed on the user computing device 102, or in structured or unstructured data obtained from external data sources. The data collection module 210 may thus communicate with the I/O interface 250 and network communication interface 260 via bus 270 to engage with external devices and data depositories. The form generation application 208 may include a document format module 212 of instructions for executing the transformation of data collected by the data collection module 210 into type and format required by appropriate tax forms, as well as the population of tax forms with the data. The form generation application may receive data from data stores 112, 114 such as tax form data and platform user data. This data is used to populate portions of the documents generated by the document format module 212, as well as by the form generation application for initial required form identification

The non-transitory machine-readable storage medium may also be used to store instructions to implement a form generation application for supporting the accepting of commercial real estate tax information and use of that information to generate tax appeal documentation within a cloud-based system, and/or a software library containing methods that call the above applications. While the machine-accessible storage medium is shown in an example implementation to be a single medium included within memory 202, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the disclosure. The term “machine-accessible storage medium” shall accordingly be taken to include, but not be limited to, solid-state memories, and optical and magnetic media.

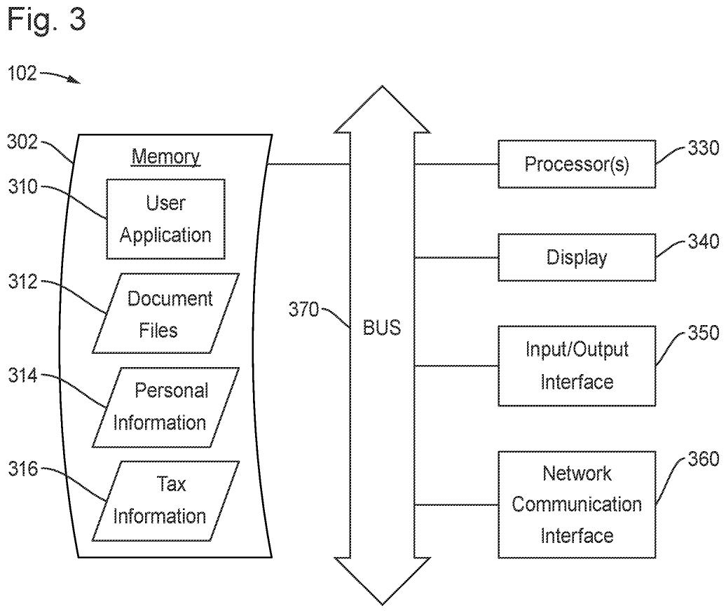

Referring now to FIG. 3, there is shown an example of a user computing device 104 within which a set of instructions, for causing the computing system to perform any one or more of the methods discussed herein, may be executed. With reference to FIGS. 1-3, the user computing device may correspond to any of the user computing device 102 of FIG. 1. In some implementations, the user computing device 102 may enable user of a commercial tax appeals platform, i.e. system 100, to input real estate information and generate commercial real estate tax appeal documents.

In certain implementations, the user computing device 102 may be connected (e.g., via a network, such as a Local Area Network (LAN), an intranet, an extranet, or the Internet) to other computer systems. The user computing device 104 may operate in the capacity of server or a client computer in a client-server environment, or as a peer computer in a peer-to-peer or distributed network environment. User computing device 104 may be provided by a personal computer (PC), a tablet PC, a set-top box (STB), a Personal Digital Assistant (PDA), a cellular telephone, a web appliance, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein for completing events of a workflow process.

The user computing device 102 includes a processing device such as a processor(s) 330, a memory 302 which includes multiples: a main memory (e.g., read-only memory (ROM), flash memory, dynamic random access memory (DRAM) (such as synchronous DRAM (SDRAM) or DRAM (RDRAM), etc.) and a static memory (e.g., flash memory; a static random access memory (SRAM), etc.), and a data storage device (e.g. data store), which communicate with each other via a bus 370.

Processor 330 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processor 330 may also be one or more special-purpose processing devices such as an application specific integrated circuit (ASIC), a field programmable gate array (FPGA), a digital signal processor (DSP), network processor, or the like. The processor 330 is configured to execute processing logic for performing the operations and steps discussed herein.

The user computing device 102 may further include a network communication interface 360 communicably coupled to a network 120. The user computing device 102 also may include a video display unit such as display 340 (e.g., a liquid crystal display (LCD) or a cathode ray tube (CRT)), an input/output interface 350 including an alphanumeric input device (e.g., a keyboard) and, or a cursor control device (e.g., a mouse), and an optional signal generation device (e.g., a speaker).

The memory 302 may include a computer-readable storage medium (e.g., a non-transitory computer-readable storage medium) on which may store instructions encoding any one or more of the methods or functions described herein, including instructions encoding a user application 310 for implementing methods for obtaining and transmitting data related to commercial real estate properties owned or managed by the user. The user application 310 may communicate with the I/O interface 350 to obtain scanned documents, pdfs, or other document files 312 from the user. The user may also engage with the IO interface 350 to provide manually entered personal information 314 and, or tax information 316. Tax information 316 may also be obtained from external sources such as taxing authorities, and may include tax payment receipts, and other information obtained from relevant taxing authorities.

The non-transitory machine-readable storage medium may also be used to store instructions to implement a user application 310 for supporting the accepting and submission of commercial real estate tax information within a cloud-based system, and/or a software library containing methods that call the above applications. While the machine-accessible storage medium is shown in an example implementation to be a single medium included within memory 302, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the disclosure. The term “machine-accessible storage medium” shall accordingly be taken to include, but not be limited to, solid-state memories, and optical and magnetic media.

The commercial real estate tax appeals platform, i.e. tax document generation system 100, addresses the problem of generating tax appeals forms from disparate data sources. Unlike personal income taxes, commercial real estate taxation involves information from assessor's offices, building management or ownership, rental information, such as lease terms, rental income, operational expenses, utilities information, and more. This information is stored in different locations and formats, and not all of the information may be available in electronic format or a structured data format. This makes it challenging for users to prepare and submit commercial real estate tax appeals, as information must often be gathered by a user and the appropriate appeals forms manually generated and submitted. The system 100 provides a solution that identifies data of different varieties using machine learning algorithms, transforms the data and builds jurisdiction appropriate tax appeals forms with corresponding evidence to support an appeal for the user.

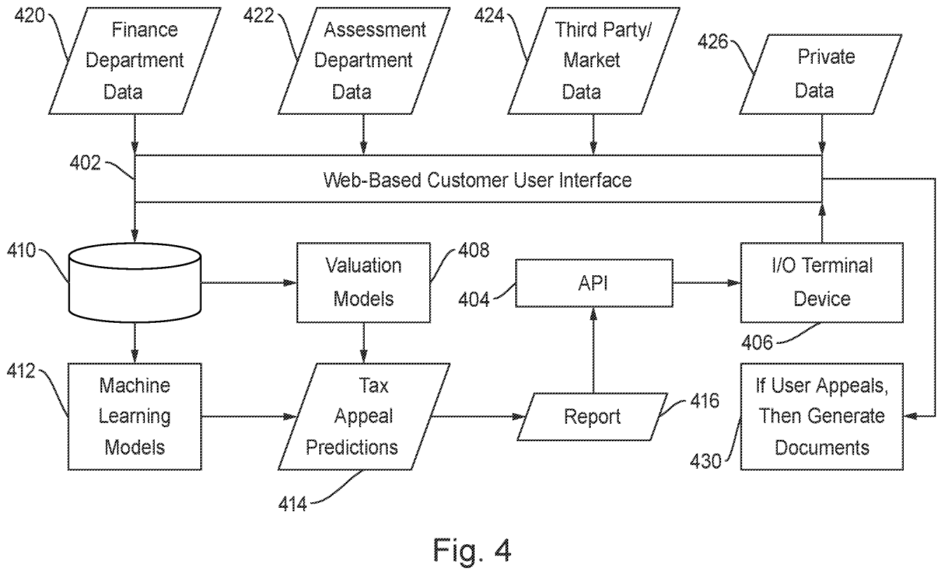

Referring now to FIG. 4, there is shown a block diagram of information flow within the commercial real estate tax appeals platform. With reference to FIGS. 1-4, the tax document generation system 100 may include several subroutines or methods. An API allows for seamless collection of data from methods 500-800 which represent data sources. The I/O Device Terminal is the user computing device 102 the medium and/or hardware transmitting information. The form generation device 110 may identify properties based on user input, GPS coordinates, metadata in user supplied images, etc.

The tax document generation system 100 may provide a web-based customer user interface 402 that is transmitted to a user computing device 102 and rendered for display in a user application 310. In this way, an application programming interface 404 may enable the user to interact with the web-based customer user interface 402 via the user's I/O terminal device 406, i.e. user computing device 102. A customer of the platform may use various input devices of their user computing device 102 such as keyboards, mice, scanners, copiers, microphones, etc. to provide information that is transmitted to the form generation device 110 via the web-based customer user interface 402.

The form generation device 110 may receive data from various data sources 420-426 via one or more web-based interfaces such as web-based customer interface 402 or via separate API specific to taxing authorities. The user provided information and the external source information may be processed using valuation models 408 machine learning models 412 to obtain tax appeal predictions 414. The form generation device 110 may generate a report explaining the predicted tax appeal outcome and transmit this report 416 to the user computing device 102 via the API for rendering in the web-based customer interface 402. Based on the report and the user's tax goals, the user may select to appeal or not appeal the tax decision. If the user selects to appeal then the tax appeal document generation system 100 generates the appeal documents for user review. In block 430.

External sources of tax data include the taxing authority department of finance 420, e.g., the remote server and the taxing authority tax assessment department 422. In various embodiments the finance department 420 may manage and retain jurisdictional tax data such as tax rates, while the tax assessor's office 422 may manage and retain property-specific tax data and jurisdictional compliance data. The form generation device 110 may use the jurisdictional compliance data to identify the forms and evidence required for a user to submit a tax appeal. The property-specific data or jurisdiction tax data may comprise a portion of the evidence needed to fill out the tax forms and support an appeal submission.

The data is transmitted to the user computing device 102 or 110 according to the requesting party and the taxing jurisdictions. Some taxing jurisdictions may require that the user request the personal information themselves and will not permit the form generation device 110 to make this data request. Information about commercial real estate tax compliance may be established in real estate tax legislation and may be managed by taxing authority finance or assessing departments 420. Relevant information may include: real estate parcel and tax identifiers; assessment values; tax rates; tax due dates; assessment appeal deadlines; assessment issuance dates; jurisdiction names; jurisdiction contact information; assessment guidelines; and metrics (rents, expenses, cap rates, adjustments/premiums,). The exact scope of data available from the finance department 420 and the tax assessor's office 422 may vary according to jurisdiction. The data may be collected using data collection module 2120 and stored in either the user data or form data in data stores 112, 114. More specifically, data related to jurisdictional requirements and compliance may be stored in the form data, while data related to a specific property will be stored in the user data in association with the user's unique identifier. Jurisdictional compliance data may be requested and stored upon initiation by a user or at regular intervals by the system 100 without requiring user engagement. Conversely, property-specific data will generally not be requested and stored until the associated user engages with the system.

Another external source of data is market data 424 which may come from various market sources and third party vendors. This data may be pulled via API to the third party data vendors and may include market rents, market expenses, market cap rates, sales comps, construction costs, taxable values, etc.

Private data 426 is provide by the user, owner, or manager of the property. This data includes property-specific income and expense information. For example, private data can include: total NLA/Units/Rooms; tenant names; tenant description/Use Type; Tenant Rent (Annual, Monthly;, PSF, etc), Tenant lease term; gross Rent; other income; OPEX; NOI; retail tenant sales PSF, TI PSF, Cap Ex. Property owners may store this data in a variety of formats including real estate management software, spreadsheet documents, physical documents, etc. The user application 310 may include optical character recognition (OCR) capabilities enabling the identification and extraction of alphanumeric characters in image files. This enables the user to scan physical documents, use image sensors to capture photos of physical documents, or use text-embedded pdf documents as input to the user application 310. The text extracted from the documents may be transformed and added to a structured data file including the recognized text and any associated information fields. The user application 310 may also request data from private data source 426, which may be cloud-based data storage of property rental information, etc. Lastly, the user may input property information into a one or more forms provided via the web-based customer user interface 402. These various forms of data may be transmitted by the user computing device 102 to the form generation device 110 via the API 404 as part of a submission via the web-based customer user interface 402. In this manner, the user computing device 102 may, via the user application 310 transform some of the data prior to submission to the form generation device. In other embodiments, the data collection module 210 of the form generation device 110 may collect and transform data into a format consistent with the tax appeals forms being generated.

A substantial amount of publicly available and private information pertaining to commercial real estate is inputted into a computerized database programmed to produce statistical standards, which can then serve as a basis for subsequent comparison with particular, selected, properties. The data may be organized and formatted to facilitate the analysis of various data points related to real estate that may include a traditional direct capitalization analysis or discounted cash flow model including metrics and property performance data such as gross rental income, pass through income, vacancy loss, bad debt, operating expenses, capitalization rates, real estate taxes and a variety of taxing jurisdiction data related to assessed values and assessments as a measure of unit for comparable properties in a respective jurisdiction (including the taxes) pertaining to selected properties. The analysis provides for a valuation of the property under analysis in order to identify whether that respective property is over assessed and warrants an appeal of the assessment with the taxing jurisdiction. Various analysis processes and machine learning algorithms assist in the analysis of the data entered in view of the information contained in the computerized data base including the generation and display of significant statistical information regarding the selected properties and the generation of various reports. The system includes programs for building a report illustrating the appealed value and relevant supporting data providing justification for the assessment appeal with the taxing jurisdiction.

In various embodiments, the web-based customer user interface 402 may enable several mechanisms for property identification. For example, the user may input the address of a commercial real estate property into a search field. The form generation device 110 uses the provided address to identify relevant taxing jurisdictions. Taxing jurisdiction options may be displayed to the user for selection. Once one or more taxing jurisdictions have been selected, the form generation device 110 matches the taxing jurisdiction with appeal methodology (mass appraisal, straight income, etc) as stored in the forms data store 112 114. The form generation device 110 executing the form generation application 208 will also search the forms data store to identify other information needed in order to predict appeals success. The information needed in order to predict appeal success will differ from jurisdiction to jurisdiction, thus the selected jurisdictions and their respective appeals methodology must be identified before the relevant factors can be identified. These factors may include cap rates, other assessment metrics to use to analyze the appeal opportunity. Information related to these factors is then collected from the user input data via the data collection module 210 and stored in the user data store 112, 114.

In another embodiment, the user may submit an image of a commercial real estate property via the form. The form generation application 208 may analyze the metadata of the image to identify a GPS coordinate for the location at which the image was taken. The form generation device 110 then uses the GPS coordinates as a search to identify the street address associated with the GPS coordinates. A map may be displayed to the user with the identified parcel illustrated as a pin on the map. The user may be prompted to confirm if the pinned location is the property of interest. If the user selects that the parcel is correct, then the form generation application 208 proceeds with matching the property to a jurisdiction and identifying appeal prediction factors.

The user may be prompted to input additional financial information regarding the property or its upkeep, and assessment values. The user application 310 may then execute one or more machine learning models 412 to generate appeal predictions 414. The appeal predictions represent a likelihood of succeeding on an appeal of a commercial real estate tax assessment for the property. The form generation application 208 may generate a report including a preliminary prediction of property valuation vs tax assessment value as well as relevant potential tax savings. This report may be used by the user to determine whether to proceed with the generation of tax appeal forms and submission of a formal request for appeal to the relevant taxing jurisdiction.

The user application 310 can build portfolios of properties stored in association with the unique user identifier each time the user logs into the system 100. Each property entered that goes through this matching process then becomes part of “my portfolio”. Properties can be stored in aggregate to be looked at later, tracked, and build a “history” of properties in the user's portfolio.

In this way, the web-based customer user interface 402 enables the easy provision of structured and unstructured commercial real estate data to the platform to generate automated real estate tax compliance reports and forms. Using this data, the form generation device 110 can digitally transmit reports and forms to specific jurisdictions quickly and in a secure environment.

The disclosed embodiments leverage several machine learning models to gather and collect data via the data collection module 210 and generate forms via the document format module 212. Data is initially ingested into the data stores by users of the system 100. Machine learning models will identify appeal opportunities by utilizing tax and financial data to identify whether a property is overassessed and ripe for appeal. The machine learning models executed by the form generation device 110 include: supervised learning models such as Regression/Classification-Logistic Regression, Decision Tree, Random Forest, Naives Bayes Classifier, Support Vector, and K Nearest Neighbor. The supervised learning models are trained on labeled data and the relationships between that data to classify appeals outcomes as likely to succeed or not likely to succeed. For example, if a user submits financial information indicating higher rents than the market data for that same property type AND the current assessment of the subject property has declined from the prior year, the result of the machine learning model would likely be that the appeal would not succeed.

A second type of machine learning model executed by the form generation device 110 is unsupervised learning such as Clustering-K Means. Unsupervised learning models analyze the data gathered through public assessment data looking for patterns or relationships between the data to determine if it is underassessed. For example, examining year to year changes in hundreds of thousands of assessments and then determining based on the analysis, what properties based on the profile (size, property type, location, etc) are out of sync with the assessment growth and assessment per unit (e.g. SF, unit, room) are over-assessed.

The various machine learning models may use reinforced learning and visually analyze outcomes and correct the ML model to refine its outcomes.

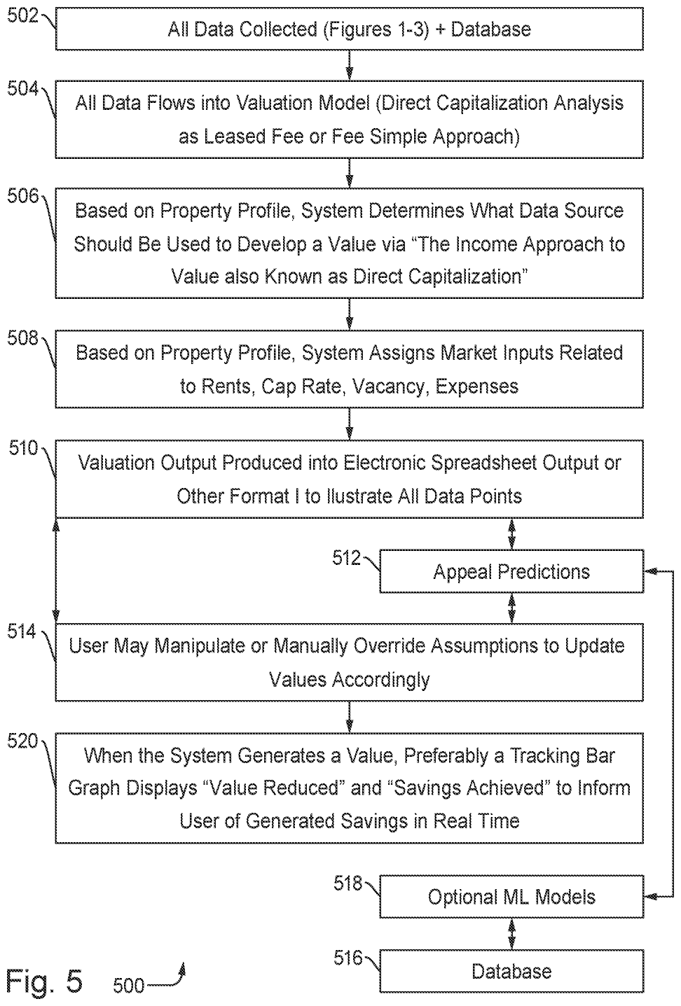

Referring now to FIG. 5, there is shown a process flow of the form generation application execution. With reference to FIGS. 1-5, the form generation device 110 may via the processor 230, execute a form generation application 208 to produce commercial real estate tax appeals forms for submission. The form generation application 208 may collect data and format the data within one or more tax appeal forms.

Document generation begins at block 502 with the collection of data input by the user and received from both private and external data sources 420-426. This data is collected by the data collection module 210 of the form generation module 208. In block 504, a filtering algorithm reviews data received as input for the models from the various data sources. The filter model flags discrepancies in the different data sources. For example, if the “market” vacancy rate is higher than the property's “actual reported” vacancy rate it will flag that data point. Once all discrepancies have been flagged, the system prompts for an optional manual override by the user. For each data point that can be manually overwritten, the form generation device 110 enables the user to “pick” from supported sources. For example, if user decides to override the imputed vacancy rate to a higher vacancy rate, the optional vacancy rates will have data sources assigned to them that will automatically be included in the written narrative as support. For example, if the vacancy rate chosen comes from a 3^{rd} party source, once the appeal narrative is produced it will have included that referenced document as an addendum.

In addition to using customer input and 3^{rd} party data to determine a valuation which in turn guides the identification of an appeal opportunity in block 514, the one or more machine learning models may, in block 518, draw on data stored in the data stores 112, 114 in block 516 to identify appeal opportunities as well. The classification models review stored outcomes to draw inference, as well as a collection of other data points to look for correlations that may indicate whether an appeal is likely to succeed. This may also be integrated into reinforcement learning patterns.

In various embodiments, the form generation application 208, may, in block 506, determine based on the state and taxing jurisdiction what approach to the direct capitalization valuation should be used. 1 of 4 data sets, or a combination thereof be used to calculate a direct capitalization for the selected property. The direct capitalization method used may be guided by data obtained from the 4 data sources 420-426 in block 508. This external data includes third party market data, data from the taxing jurisdictions assessment office, data from the jurisdictions dept of finance and/or user derived property specific data. A trained machine learning model may use the data from the data sources 420-426 as input and produce as output a selected direct capitalization method. Additional ML/AI may be incorporated to further train/teach the model to look for the best assumptions and data points to use to arrive at the most favorable property appeal value. A favorable appeal value for the user may include a value lower than the assessed/market value originally issued by the jurisdiction.

In block 510, once the property valuation is produced using the selected direct capitalization method, the user may be shown a graphic representation of the value differentiation between the valuation and the tax assessment. This may be part of a generated report or analysis provided to the user. The results of the direct capitalization may be stored in the user data store in association with the property.

If the user selects that they would like to appeal the tax assessment based on the predicted valuation, the form generation application 208 executing on the form generation device 110 searches the submitted data for comparable sales information. This external evidence of comparable sales provides strong support for the appeal of a tax assessment value for a property. If no such support is found, the user is notified and prompted to decide whether to proceed with the appeal. If comparable sales data is found, the form generation application 208 may notify the user and begin preparation of tax appeal forms. The comparable sales data may consist of a fair market value (FMV) for the property and similarly situated properties. Current FMV is drawn from Caspio or similar third party data source 424 that has gathered information/data from user input or what already exists in Caspio or other similar databases. Value and savings may be based on a quick analysis using SF, market rent, asset type, operating expenses, and market derived cap rate to calculate property value. For purposes of tax estimation, the Local tax rate x estimated value=taxes. Once the estimated taxes are calculated for both the direct capitalization valuation and the tax assessed value, these values are graphically illustrated to the user to assist in the determination of whether to pursue a tax appeal. In block 514, the user may review the valuation data and may manually adjust the values via the input device.

In block 520, the various illustrative graphics and any corresponding reports may be generated by the document format module 212 of the form generation application 208. Report may include analysis of other analytics including a comparison of the assessments of comparable properties. The data for the comparable properties is obtained from the data sources 420-426.

The form generation application 208 executes the document format module 212 to use the collected property data, comparable sales data, and any other jurisdiction-specific evidence to pre-fill or complete the jurisdiction tax appeal forms. The form templates are stored in the forms data store 112, 114 and may be transmitted to the form generation device 110 upon selection by the user of the jurisdictions for appeal. The document format module 212 may modify the shape, size, font, emphasis, or other characteristic of the data to match that required by a form being completed. In this way the data is formatted to fit the jurisdiction's appeals forms and reduce the likelihood that an appeal will be rejected based on formatting issues. After all auto-completion is finished, the forms are transmitted to the user computing device 102 for display and review. The user may use an input device to finish filling any remaining fields and then submit the forms upon approval. A notification indicating the status of the appeal acceptance is transmitted to the user computing device 102 upon determination that the appeal was received by the target jurisdiction.

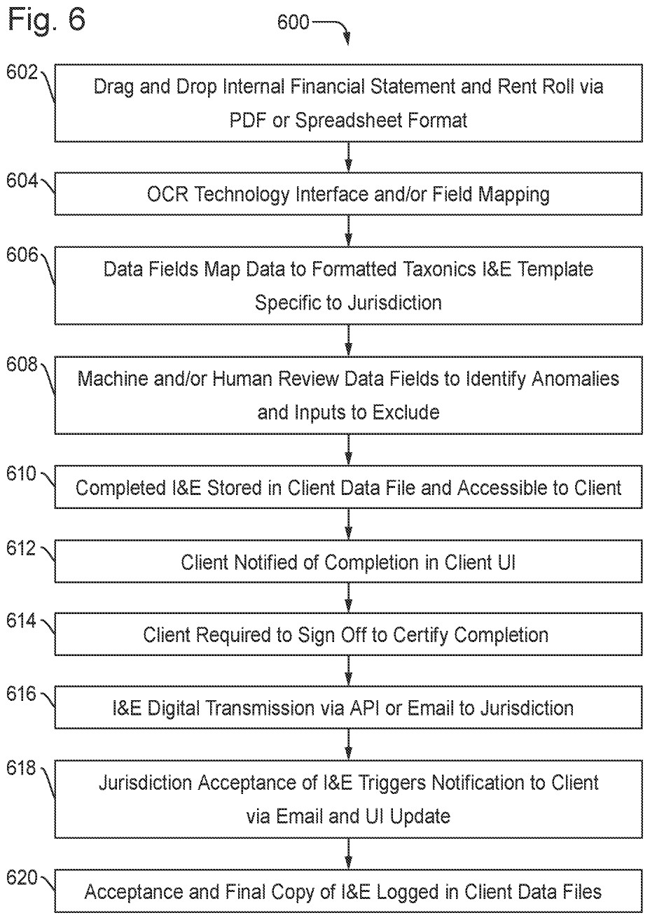

Referring now to FIG. 6, there is shown a process flow for an income and expenses submission process. With reference to FIGS. 1-6, the form generation device 110 executing the form generation application 208 may require a user to input additional income and expense information for a selected commercial real estate property. This income and expenses information increases the accuracy of tax valuation predictions as well as predictions about the likelihood of appeal success, and also may be a required submission for assessment and taxation compliance in certain taxing or assessment jurisdictions. The web-based customer user interface 402 may prompt the user to input this property-specific data for each property entered by the user.

For each property entered into the system 100, the user may, in block 602, upload financial statements via the user application 310. These financial statements may be in various file formats. If the document file is not recognized as containing text, then in block 604, an OCR function may be run on the file to identify and extract alphanumeric text. The data is transmitted from the user computing device 102 to the form generation device 110. The data collection module 210 and the address of the property is used to identify the relevant jurisdictions. In block 606, the document format module queries the forms data store 112, 114 for the proper income and expenses form information for the relevant jurisdictions and imports these forms. The collected income and expense data is then added to the jurisdiction-specific forms as field entries or appended documents. In block 608, the document format module 212 may also complete user information fields using the user's profile data stored in the user data store 112, 114. The resulting forms are transmitted to the user computing device 102 in block 610 for display. In some embodiments, the resulting form is accessible via a client user interface in block 612. This client user interface may require authentication, such as signing on via a user name and password, in a web portal or website. If there are fields that could not be automatically filled by the form generation device 110, then the user may manually complete those fields in block 614 before submitting the forms to the relevant jurisdictions. If all forms are completed, the user may review and select to submit the forms to the relevant jurisdictions.

In block 616, a computing device at the receiving taxing jurisdiction may review and accept the submitted forms. Some jurisdictions may transmit an acceptance and final copy of the forms to acknowledge receipt. Such acceptance may include transmission of a notification message to the user computing device. In block 618, jurisdiction acceptance triggers notification to the client via an email as well as a user interface update. In block 620, the acceptance and final copy of the forms is logged in the client data files.

In some embodiments, the tax appeals document generation system 100 may also be used to generate appeals for solid waste assessments or similar non-ad valorem assessments. As with property valuation assessments as described above, solid waste assessments may be reviewed by machine learning models to determine a likelihood of success on appeal. Data may be received by the form generation device 110 from upload via template (CSV file, or similar compatible file format) or individual input from user. A machine learning model may review the solid waste assessment documentation and determine whether an appeal is likely to succeed. The output of the comparison is a graphical representation of a comparison of the user's current solid waste fee and the revised solid waste fee based on the model prediction. This graphical depiction may thus illustrate “savings” to the user. The user may use an input device to select to appeal their current solid waste fees. The form generation application 208 may proceed with selecting the jurisdiction-specific appeal forms and completing the forms for submission as is described for valuation appeals above. Once approved by the user, the forms are submitted to selected jurisdictions for review.

It is to be understood that the above description is intended to be illustrative, and not restrictive. Many other implementations are apparent upon reading and understanding the above description. The scope of the disclosure should, therefore, be determined with reference to the appended claims, along with the full scope of equivalents to which such claims are entitled.

In the above description, numerous details are set forth. It is apparent, however, that the disclosure may be practiced without these specific details. In some instances, structures and devices are shown in block diagram form, rather than in detail, in order to avoid obscuring the disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving”, “determining”, “identifying”, “updating”, “copying”, “publishing”, “selecting”, “utilizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems appears as set forth in the description below. In addition, the disclosure is not described with reference to any particular programming language. It is appreciated that a variety of programming languages may be used to implement the teachings of the disclosure as described herein. The disclosure may be provided as a computer program product, or software, that may include a machine-readable medium having stored thereon instructions, which may be used to program a computer system (or other electronic devices) to perform a process according to the disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein, but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A system including:
a user computing device configured to:
receive at least one real estate document;
receive tax information form a user;
transmit the real estate document and the tax information to a form generation device; and
a form generation device configured to:
receive property documents and tax information from a user device;
identify a taxing entity based on the tax information and the property document;
calculate a property valuation;
generate one or more tax appeal documents based on the calculated valuation;
transmit the tax appeal documents to a taxing entity server.

2. The system of claim 1, wherein the form generation device calculates the property valuation by:
executing a first machine-learning model to identify a direct capitalization model based on the tax information and the property document; and
execute the identified direct capitalization model to obtain the calculated value.

3. The system of claim 1, wherein the form generation device is further configured to:
execute a filter model to identify errors in the tax information and the property documentation; and
prompt the user for manual correction of identified errors.

4. The system of claim 1, wherein the user computing device is further configured to:
execute optical character recognition on property documents to identify alphanumeric characters; and
transmit the OCR'd property document to the form generation device.

5. The system of claim 1, wherein the form generation device is further configured to:
Analyze the metadata of the property document to identify a GPS coordinate;
Determine a property address associated with the GPS coordinate; and
Prompt the user to confirm that the identified property address is correct.

6. A system including:
a user computing device configured to:
receive at least one real estate document;
receive tax information form a user;
transmit the real estate document and the tax information to a remote server; and
a remote server configured to:
receive property documents and tax information form a user device;
identify a taxing entity based on the tax information and the property document;
calculate a property tax rate for the taxing entity;
generate one or more tax filing documents;
transmit the tax filing documents to a taxing entity server.

7. A system including:
a user computing device configured to:
receive at least one real estate document;
receive tax information form a user;
transmit the real estate document and the tax information to a remote server; and
a remote server configured to:
receive property documents and tax information form a user device;
identify a taxing entity based on the tax information and the property document;
calculate a solid waste assessment;
generate one or more solid waste appeal documents based on the calculated solid waste assessment;
transmit the tax appeal documents to a taxing entity server.
